(19) United States
(12) Patent Application Publication
(10) Pub. No.: US 2009/0213742 A1
(43) Pub. Date: Aug. 27, 2009

(54) Telephone Communication Monitoring Device and Method

(75) Inventors: Robert French, Mississauga (CA); Allen Keeling, Owen Sound (CA); Craig White, Richmond Hill (CA); Ray Ransom, Big Bear City, CA (US)

Correspondence Address: THE WEBB LAW FIRM, P.C., 700 KOPPERS BUILDING, 436 SEVENTH AVENUE, PITTSBURGH, PA, 15219, US

(73) Assignee: NEUROWARE CORPORATION, Mississauga (CA)

(21) Appl. No.: 12/089,443

(22) PCT Filed: Oct. 6, 2006
(86) PCT No.: PCT/CA06/01653

§ 371 Date: Feb. 5, 2009

(30) Foreign Application Priority Data
Oct. 7, 2005 (CA) 2522557

(51) Int. Cl. H04J 1/16

(52) U.S. Cl. 370/252

(57) ABSTRACT

A telecommunication system management device, the device comprising: a means to connect the device to a source of power; a means to connect the device to a multiplexed telephone signal; a means to provide the device with a destination network address; a decoder, to receive the multiplexed telephone signal and to extract control information from the multiplexed telephone signal; a converter, to receive inputs comprising the destination network address and the extracted control information, and to convert the inputs into a network compatible output signal; and a means to connect the device to a network, to permit the device to transmit the output signal over the network; wherein, the extracted control information can be sent to the destination network address.

### FIELD OF THE INVENTION

This invention relates to the general field of telecommunications, and more particularly to multiplexed telephone signals.

### BACKGROUND OF THE INVENTION

In order to meet the needs of large customers, such as those having about 50 or more workers, telephone companies provide multiple channel telephone lines in a convenient bundled form known as a “T1” service or line. Physically, T1 lines are dedicated wiring connections between a cross-connect at a telephone company's central office and a PBX (private branch exchange) at a customer site. Communication techniques such as time division multiplexing are employed so that the multiple channels can share a single wire pair, coax, or fiber optic cable. A single T1 line has a carrying capacity of up to 24 channels or voice conversations, and operates at a speed of about 64 kilobytes/second per channel, or about 1.5 megabytes/second total.

A feature of T1 technology is that one of the channels may be used to control the other 23 channels used for voice in the same line, as well as some or all of the voice channels in other T1's at the same site. Control information is generally characterized as being of three types or “layers”. Layer one information is simply the physical connection. Layer two comprises “framing” information, such as the fact that a packet of information of a given size is being transmitted on a particular voice channel. Layer three information is the most complex and detailed, and includes for example, the start and stop time of a call, and the reason for termination, such as by hang up (most often) or system failure. By industry convention, control and voice channels are also referred to as “D” and “B” channels, respectively.

A problem with present T1 service is that there is little or no information available to a customer regarding actual system usage. As a result, it can be difficult for a customer to accurately assess how many T1 lines it really needs. For example, a call center having 60 workers might order three T1 lines to ensure that no caller gets a busy signal, when in fact two lines might be sufficient given actual usage patterns.

Another aspect is that customers may not even be aware that a problem exists until the system goes down or it receives caller complaints. For example, technical malfunctions in a T1 line, such as chronic failure of several channels, might go undetected for an extended period of time. Such a situation would likely lead to busy signals and customer dissatisfaction. Further, upon being informed of the busy signals but without understanding the true nature of the problem, the customer may well respond by ordering an additional, unnecessary T1 line. Since T₁ lines are costly, leasing more lines than required will unnecessarily increase a customer's costs.

One attempted approach to this issue involves installing a computer at a customer site. The computer is provided with at least one data card which reads the incoming T1 signals, extracts certain control information, and stores it on the computer where it is available for analysis. However, while the data provided in this way may be helpful, it can be difficult to access. It is also specific to the particular site, and therefore may not be useful or convenient for customers having multiple sites. The approach is also costly as it requires a dedicated computer, one or more specialized cards for a given number of T1 lines, and analysis software that may need to be customized and that must be installed on site.

Another approach involves the use of small hand-held diagnostic devices, which can access and store a limited form of T1 control data in internal flash memory. However, these devices have only a limited amount of memory needed for diagnostics, and accordingly can only store small amounts of data, representing perhaps 10 to 30 minutes of information. This is not enough to be useful for most customers. Further, the data is not conveniently available for computer processing since it resides in the portable device.

### SUMMARY OF THE INVENTION

What is desired is a monitoring device and method which overcomes one or more of the above problems.

The device should preferably provide full and complete data of D or control channel activity on an incoming T1 line. The data should preferably be available in real time, for immediate analysis, and also be enabled for storage so that more comprehensive reports can be performed over any desired historical time frame. Preferably the data can be directed to a location of choice, including one off-site. More particularly the data will preferably be directed to a centralized website having a processor available to analyze and report the data. Customer access to the reports may conveniently be over the Internet. Data from multiple sites will preferably be directed to a central location, such as the centralized website, so that all the data relevant to a particular customer can be jointly analyzed and reported. The device will also preferably be low in cost, easy to install, and not demand substantial overhead, space, or power requirements at the customer site.

The method of monitoring of the present invention will preferably involve obtaining complete D channel information and directing it to a location within the site, or off-site such as at an Internet website or Internet-based data collection server. The present invention also provides a method of providing telecommunication services. The method preferably involves installing a telecommunication management device that obtains and provides control channel information to a central processor. The processor preferably produces real-time and off-line reports which can be accessed by the customer over the Internet.

Accordingly, there is provided a telecommunication system management device, said device comprising:
a) a means to connect the device to a source of power;
b) a means to connect the device to a multiplexed telephone signal;
c) a means to provide said device with a destination network address;
d) a decoder, to receive said multiplexed telephone signal and to extract control information from said multiplexed telephone signal;
e) a converter, to receive inputs comprising said destination network address and said extracted control information, and to convert said inputs into a network compatible output signal; and
f) a means to connect the device to a network, to permit said device to transmit said output signal over the network;
wherein, said extracted control information can be sent to said destination network address.

### BRIEF DESCRIPTION OF THE DRAWINGS

Reference will now be made, by way of example only, to preferred embodiments of the invention as illustrated in the attached figures.

FIG. 1 is a schematic view of the prior art T1 telephone system;

FIG. 2A is a schematic view of the T1 (D) line of FIG. 1;

FIG. 2B is a schematic view of the information carried on the T1 (D) line of FIG. 1;

FIG. 3 is a schematic view of the T1 telephone system incorporating the device and method of the present invention;

FIG. 4 is a schematic view of the device of the present invention;

FIG. 5A is a schematic view of the information carried at point 5A of FIG. 4;

FIG. 5B is a schematic view of the information carried at point 5B of FIG. 4;

FIG. 5C is a schematic view of the information being carried at point 5C of FIG. 4;

FIG. 6 is a schematic view of another embodiment of the device of the present invention;

FIG. 7A is a schematic view of a multiple T1 installation at a single site incorporating the embodiment of the present invention shown in FIG. 4;

FIG. 7B is a schematic view of a multiple T1 installation at a single site incorporating the embodiment of the present invention shown in FIG. 6; and

FIG. 8 is a schematic view of a multiple T1 installation at multiple sites incorporating the present invention.

### DETAILED DESCRIPTION OF THE PREFERRED EMBODIMENTS

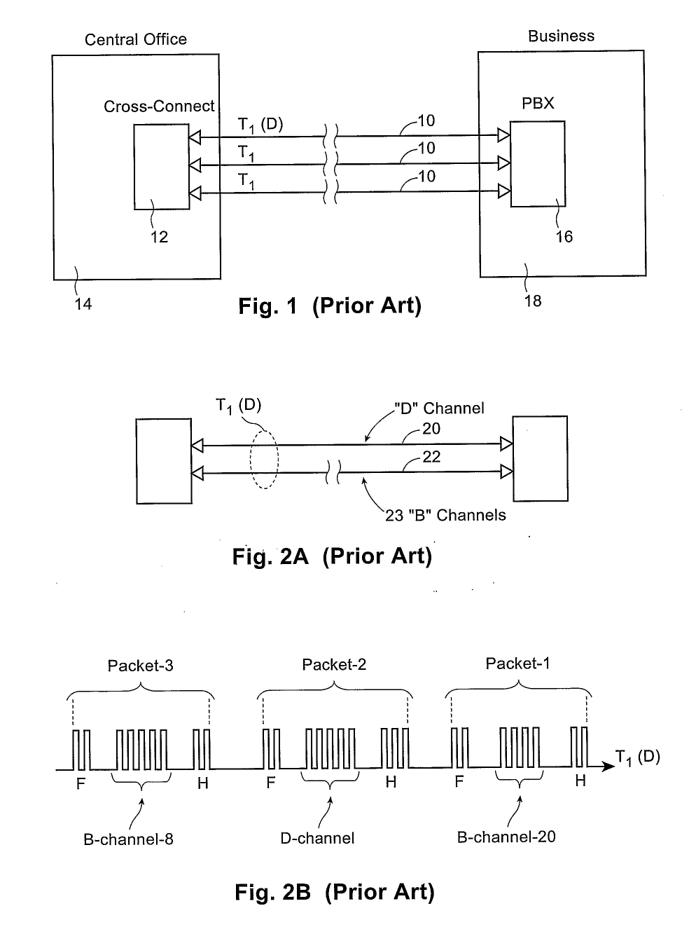

The general configuration of a T1 multichannel telephone system is shown in FIG. 1, for a system having three T1 lines 10 as an example. The T1 lines are shown as dedicated connections between a cross-connect 12 at a telephone company central office 14, and a PBX 16 of a customer or “business” site 18. While physically each T1 line is a single wire-pair or coax cable, in communication terms each T1 line has a capacity of 24 channels, and can therefore carry up to 24 voice conversations simultaneously.

The T1 multichannel telephone system comprehends the T1 line or service using the “Primary Rate Interface” which presently adheres to the International Telecommunications Union (ITU) standard Q931. Outside of North America this type of multi-channel telephone service is generally known under other names such as “E1” or “J1” rather than T1, and has different technical parameters, but is otherwise broadly similar to the T1 following the ITU Q931 standard. It can be appreciated that the device and methods of the present invention also comprehend these various international forms of the multi-channel telephone service.

The T1 line shown as T1 (D) dedicates one channel for control. This is shown in FIG. 2A, which represents the T1 (D) line schematically as having one “D” or control channel 20 and 23 “B” or voice channels 22. FIG. 2B shows the use of time division multiplexing to convey multi-channel information over a single T1 wire-pair or coax. It can be seen that the information consists of a series of packets, each of which carries data pertaining to one channel. Each packet has tag information in the form of a header H and footer F, which define the start and end points of the packet and the type of information contained within.

The T1 line shown in FIG. 2B is a T1 (D) line and therefore has both B and D channel information. Packets that relate to “B” or voice channels contain actual segments of voice communication of the callers, while “D” or control packets contain information about one of the “B” channels. For example, in FIG. 2B packets 1 and 3 contain actual voice communication on B-channels 20 and 8, respectively. Packet 2 contains D-channel information, which may be, for example, the information that a call commenced on B-channel 15 at 2:41 p.m.

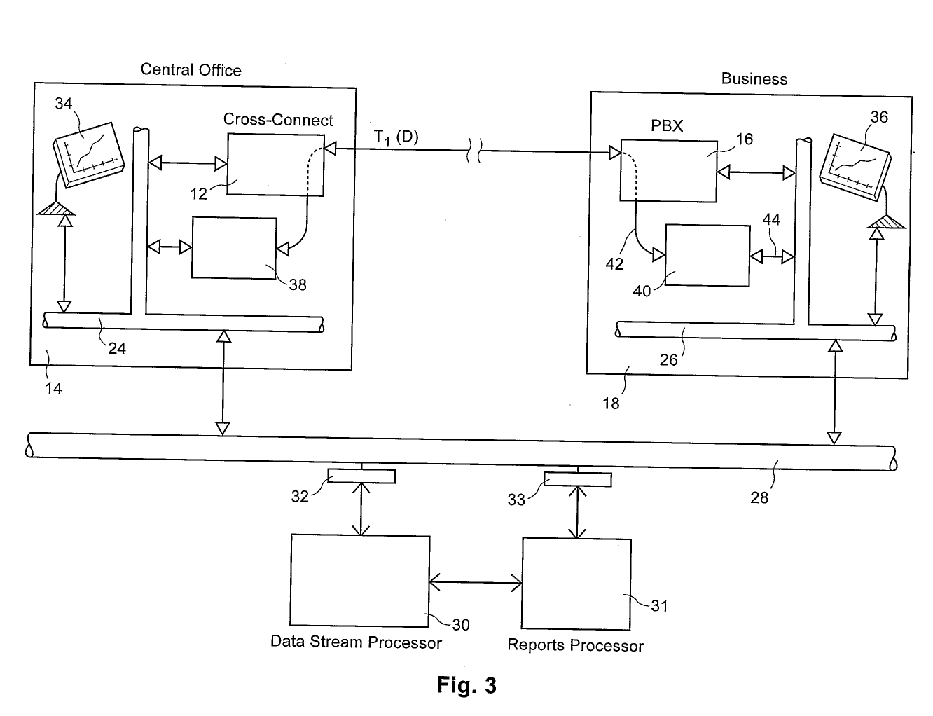

A telecommunication or multichannel T1 telephone system incorporating the device and method of the present invention is shown in FIG. 3. The T1 line 10 has a control or “D” channel as one of its 24 channels, and is accordingly designated as T1 (D). Each of the central office site 14 and business site 18 have local area networks, indicated as 24 and 26 respectively. The local area networks connect the various devices within each site both to each other and to a broader Internet network 28. There may also be local processors at either site, for example local processor 34 at the central office 14 and local processor 36 at the business site 18. There is also a data stream processor or network server computer 30, located at IP address 32 on the Internet 28, and a reports processor 31 operatively connected to the data stream processor 30. The reports processor 31 may be accessible at the same IP address 32 or at another IP address 33.

A telecommunication system management or monitoring device 38, 40 of the present invention is shown in FIG. 3 installed at both the central office 14 and business site 18 respectively. In the operation of the present invention, the management device may be present at either or both of the sites 14 and 18.

The broad function of the management device 38, 40 is shown in FIG. 3. With reference for example to the business site 18, the management device 40 receives as input a monitor signal 42 corresponding to the T1 line containing control information entering the site. The device 40 produces an output signal 44 which is transmitted over the local area network 26. Accordingly, the signal 44 may be received at any point accessible by the network 26, including local processor 36 and/or data stream processor 30. As discussed in greater detail below, the network compatible output signal 44 contains information which may be processed and made readily accessible, to assist in the management and planning of the telecommunication system.

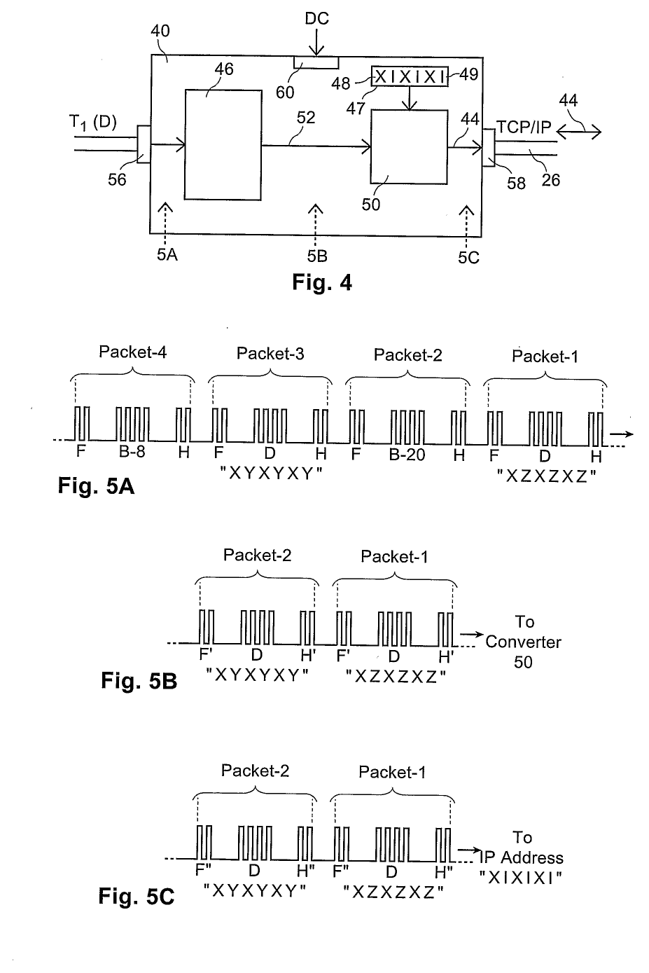

A more detailed view of the management device 40 is shown in FIG. 4. It can be seen that the device 40 includes a decoder 46, an address means 48 to provide the device 40 with a destination network address 49, and a converter 50. The management device 40 also includes a power means 60 to connect the device 40 to a source of power, a communication line means 56 to connect the device 40 to the multiplexed telephone signal T1 (D) 10, and a network means 58, to connect the device 40 to a network.

The decoder 46 receives the multiplexed telephone signal T1, containing a control channel 20, and extracts the control information of the D-channel from the overall signal. More particularly, the decoder 46 produces an output D-channel signal 52 which contains only the D-channel information from the input T1, and excludes actual B-channel content. Further, the signal 52 will include both layer 2 and layer 3 information from the D-channel.

The decoder 46 function is further illustrated in FIGS. 5A and 5B. FIG. 5A shows a representative data stream of four packets from the input T1 (D) signal. As indicated, packets 1 and 3 contain D-channel information symbolically represented as “xzxzxz” and “xyxyxy” respectively. Packets 2 and 4 contain voice data from B-channels 20 and 8. The individual packets are distinguished in time by the headers H and footers F applied to the beginning and end of each packet. This signal is located at the input to decoder 46, at the position designated “5A” in FIG. 4.

The decoder output or D-channel signal 52 is at position “5B” of FIG. 4 and illustrated in corresponding FIG. 5B. It can be seen that signal 52 contains only the two packets that correspond to D-channel packets 1 and 3 of FIG. 5A, and that B-channel packets 2 and 4 from FIG. 5A have been dropped. Packets 1 and 2 of signal 52 contain the same D-channel data “xzxzz” and “xyxyxy” as packets 1 and 3 of FIG. 5A, except now the tag information is preferably changed to H′ and F′. The new tags are configured as appropriate to efficiently transmit the data to the converter 50. More particularly, since the signal 52 in the device 40 of FIG. 4 only needs to travel a short distance on a single board, the tag information H′ and F′ will generally only need to follow a relatively simple data protocol.

The decoder 46 may be implemented by any electronic or computer hardware or semiconductor chip that is configured to accept an input bit stream, such as that of a T1, synchronize with the timing of the input stream, and filter or pass those segments which it identifies as belonging to the desired group. In particular, interface chips having model number MT9076BP manufactured by Zarlink Semiconductor Inc. of Ottawa, Canada, have produced adequate results when used in conjunction with a micro controller and memory. In particular, since the decoder hardware such as interface chips are configured to receive a T1 signal, the decoder 46 will read or listen for packets of digital data arriving at the standard T1 speed of about 1.5 Megabytes per second. The decoder 46 will identify any header or footer information associated with the various channels, which will necessarily comprise mostly B-channel information. In the course of tracking the channel information the decoder will identify the specific D-channel information and allow that data to pass while discarding the B-channel signal.

The destination network address 49 is a network or IP address of a desired destination for transmission of the D-channel data. In FIG. 4, the destination network address 49 is represented by the symbol “x1x1x1”. With reference to FIG. 3, the address 49 may be any location on the local area network 26 or broader Internet 28, but will preferably be a site such as the IP address 32 of data stream processor 30 and/or the corresponding network address of local processor 36. The data stream processor 30 is preferably a network server computer located at an Internet IP address, of a vendor, seller, operator, or service provider of the method of monitoring a telecommunication system of the present invention. Alternatively, a user of the telecommunication system at the business site 18 may wish to process the data at the local processor 36. Accordingly, the destination network address will likely be set to match the network address of the data stream processor 30 and/or that of the local processor 36, as required. The destination network address 49 may accordingly be more than one address if desired.

The destination network address 49 should preferably be an address recognized by a standard network or Internet routable protocol of a type such as TCP/IP or IPv6. Under this standard, locations on the local network 26 can be addressed in the same manner as those on the broader Internet 28.

Preferably, an electronic copy of the destination network address 49 will be held or stored in an electronic memory location 47 on the device 40. The memory location 47 may be in flash or dynamic ram, or located on a fixed or hard drive, and will be operatively connected to, or accessible to be read or referenced by the converter 50. The destination network address 49 will preferably be dynamically delivered to the device 40 when the device 40 is in use. In that context, the address 49 may be changed from time to time, as required. The present invention also comprehends other types of delivery of the address 49. For example, the address 49 may be pre-loaded into the device 40 during manufacture, or set electronically or manually by a technician upon installation of the device at the site location.

The address means 48 comprehends the elements or components used to provide the device 40 with the destination network address 49. Accordingly, one preferred form of the address means 48 will be the local memory location 47. More broadly, the address means 48 may comprise any other support hardware, software, components, or connecting elements that may be involved in delivering the destination network address 49 to the device 40 or to the memory location 47 on the device 40.

Preferably the address means 48 is configured to permit the destination network address 49 to be changed or varied in accordance with changes in desired processor locations or changes in the composition of the network. For example, if the IP address 32 of the data stream processor 30 changes, the address means 48 will preferably be used to change the destination network address 49 accordingly. Preferably the address means 48 may be configured to be accessible by a remote user, such as a service administrator located at the data stream processor 30, as well as by a local user at the site location.

The converter 50 of the present invention is configured to receive as inputs the destination network address 49 and the extracted control information contained in signal 52, and to convert or transform these inputs into the network compatible output signal 44. In this way, the extracted D-channel control information can be sent to the location on the network having an IP address corresponding to the destination network address 49.

In particular, the converter 50 receives the signal 52, strips the tag information that may have previously been applied by the decoder 46, and applies new header, footer, or other tag information that corresponds to the Internet or network routable protocol, and which incorporates the destination network address. In this way, the signal 44 may be sent to any location on the network. This is illustrated in FIGS. 5B and 5C, which show the transformation of signal 52 into signal 44 by the converter 50. As indicated, the packets 1 and 2 of each signal contain the same D-channel data “xzxzxz” and “xyxyxy” that were present in the original input T1 signal. The tag information of the packets in signal 44 however is changed, as shown by the symbols H″ and F″, to represent a network routable protocol directed to IP address “x1x1x1”. It can also be appreciated that the present invention comprehends converting the data to other network routable protocols than TCP/IP or IPv6.

Preferably the converter 50 transmits the individual D-channel packets in the same size as they are received, since the T1 packet size is suitably small for network or Internet transmission. Alternatively, if desired two or more successive packets may be combined and transmitted as a burst. In that case, the network or Internet protocol may well break up the burst into smaller segments which are routed by the Internet to the destination address. Further, if the destination network address 49 comprises two or more IP addresses, such as IP address 32 on the Internet 28 and another location on the local area network 26, the converter 50 may be configured to send two packets out on signal 44 for each packet received in on signal 52. The two packets would differ only in being directed to the different IP addresses.

The converter 50 may be implemented as an electronic signal processor chip, operated in conjunction with a general computer or processing chip and sufficient memory to store the destination network address 49. A signal processor chip such as the model LAN91 C96QFP from SMSC Corporation has been found to be adequate.

In addition to the basic functionality provided by the above hardware configuration, it would also be advantageous for the converter 50 to contain additional general processing software and/or memory so that further functions useful in the operation of the management device 40 could be provided. These include the ability to check for software updates from the data stream processor 30, ping testing the decoder 46 to confirm that it is operating during periods when there is no input T1 signal, and verifying routing and firewall settings on the local area network 26. It is also advantageous for there to be sufficient internal memory available to cache the signal 52 if the connection to the Internet 28 becomes temporarily unavailable.

Another useful feature is for the converter 50 to have the processing power and memory required to act like a device on the local area network 26. With this capability, when the management device 40 is powered up the converter 50 will broadcast its presence to the network as a new device and request an IP address. As with other network devices, it would receive in response from the network (DHCP) server an IP address and additional network addresses such as that of a gateway and DNS server. The converter 50 of the present invention can also be configured to function with fixed network information, such that it does not need a DHCP server.

It is also preferable for the converter 50 to be configured to send the output signal 44 as a continuous data stream to the destination network address using secure socket layer (“SSL”) or equivalent technology. This type of transmission is preferred because of its high security features, which include a closed interface, closed port, encryption, dedicated connection, and inability to be tapped.

The management device 40 of FIG. 4 is a first or preferred embodiment in which the device elements are housed on a single unit or electronic board or card. The device accordingly includes the communication line means or input connector 56 to receive the T1 signal, and the network means, output connector, or ethernet adaptor 58 to connect the device 40 to a network, to permit the device to transmit the output signal 44 over the network. The device further includes the power means 60, to connect the device 40 to a source of power.

The communication line means 56 is preferably a bantam jack, but may also be an ethernet jack. More broadly the means 56 is any element or component capable of attaching or connecting to a multiplexed telephone signal such as a T1. The means 56 accordingly may further comprehend components capable of receiving a wireless signal, in the event that the multiplexed telephone signal is transmitted wirelessly. The network means 58 is preferably an ethernet jack, but may include a token ring connector or any means by which the output signal 44 may connect with and be transmitted over a network. The power means 60 is preferably a DC power connector, configured to receive and connect with a standard DC power source of about 3.3 volts. It can be appreciated that other voltage input levels or types, such as AC power, may be used with the present invention. The power means 60 may be configured as appropriate, such as by including power conditioning means, to accommodate the input electrical power.

The input T1 (D) signal 10 may be tapped off the PBX 16 or from a Pair Gain Unit on the T1, using bantam jack type connectors. The board 40 should preferably also be configured to have external features that enable it to be installed in a PBX card slot or rack, or that allow it to be conveniently mounted on a wall. This embodiment of FIG. 4 is generally preferred, because it is usually more convenient to install and manage a single unit or housing than one having multiple units. In addition, if the board is manufactured in quantity the cost of the device 40 will likely benefit from a lower per-unit cost of production.

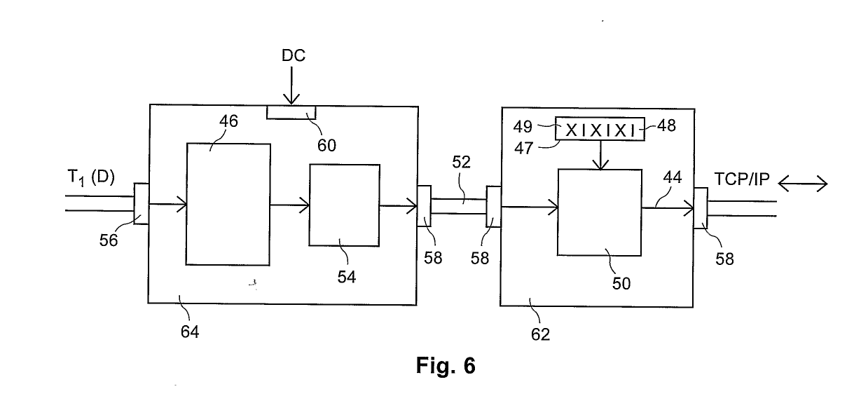

A second or alternate embodiment of the management device 40 having two units or housings is shown in FIG. 6. The first unit is an electronic board or decoder card 64, which houses the decoder 46 and an ethernet converter 54. The ethernet converter 54 functions to convert the control channel output of the decoder 46 to an ethernet compatible signal. Since this signal is only communicating with a single device, as discussed below, a relatively simple communication protocol such as UDP is generally preferred.

The second unit in this embodiment is a stand alone dedicated computer 62, which houses the converter 50, destination network address 49 in memory location 47, as well as a general purpose processor and memory. In order to maintain low cost and occupy a minimum of space the computer is preferably a “stripped down” machine having a reduced number and level of components. A stand alone computer that has been found to be adequate is the Vulcan™ model from Arcom Corporation. This device is available at relatively low cost, and is very small, having the dimensions of about a 4 inch by 6 inch cube. This model of computer 62 has about 16 megabytes of flash memory, 64 MB of volatile RAM, and does not have a hard drive or other form of fixed memory.

In using this embodiment, a separate decoder card 64 is required for each T1 (D) input, but only one computer 62 is needed at the site. Accordingly, in some circumstances this embodiment may be preferred, such as where there are a large number of input T1 (D) signals. In that case the converter function would be conveniently provided by the single processor in the computer 62, rather than being replicated across each board 40. Another benefit of this embodiment is that the computer 62 is a readily available off-the-shelf item, and the board 64 is relatively simple to design and manufacture compared to the all-in-one board 40 of FIG. 5. Accordingly, this second embodiment may be preferred for quick assembly or prototyping.

Referring to FIG. 3, the data stream processor 30 is a network service computer accessible at a dedicated IP address 32, and preferably operated by an administrator or vendor of the management device of the present invention. The processor 30 may be a general purpose computer such as a PC having sufficient processing power and memory to receive, store, and process the D-channel data stream being transmitted by the management device 40.

The reports processor 31 is also a general purpose computer, operatively connected to the data stream processor 31. In particular, the reports processor 31 is configured to read the real time and historical D-channel data stored in the data stream processor. The reports processor 31 is preferably configured to be accessible as an Internet website, located at port 80 of its IP address. In FIG. 3 the reports processor 31 is shown connected to the Internet 28 at IP address 33, but may alternatively connect to the same IP address 32 as that used by the data stream processor 30, if desired. Finally, a third processor, not shown in the figures, may be used to process and transmit software updates to the management device 40.

All of the three processors may be implemented as separate computers or devices, or alternatively represent different functions of a single computer or processor. Therefore, the data stream processor 30, reports processor 31, and updates processor may all be the single processor 30 connected at IP address 32 shown in FIG. 3. In that case, where the various functions are performed by a single computer operating out of a single IP address, it is preferable for there to be separate inbound ports at that address. For example, the D-channel data stream may be input at port 28,081, the reports processor communication may be received at port 80, and the updates processor communication may occur over port 29,932. Similarly, at the business site 18, the management device 40 preferably communicates over two outbound ports, one dedicated to the D-channel data stream being transmitted in SSL format, and another to send and receive software update information.

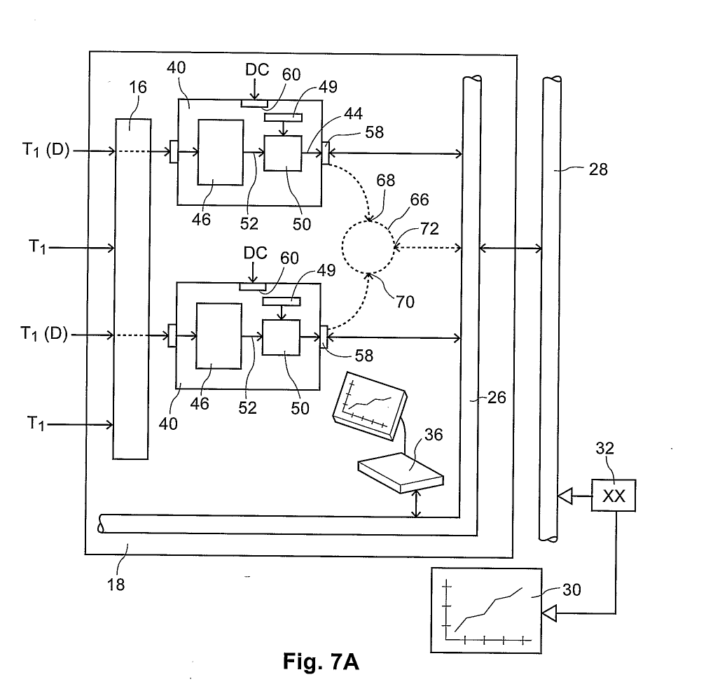

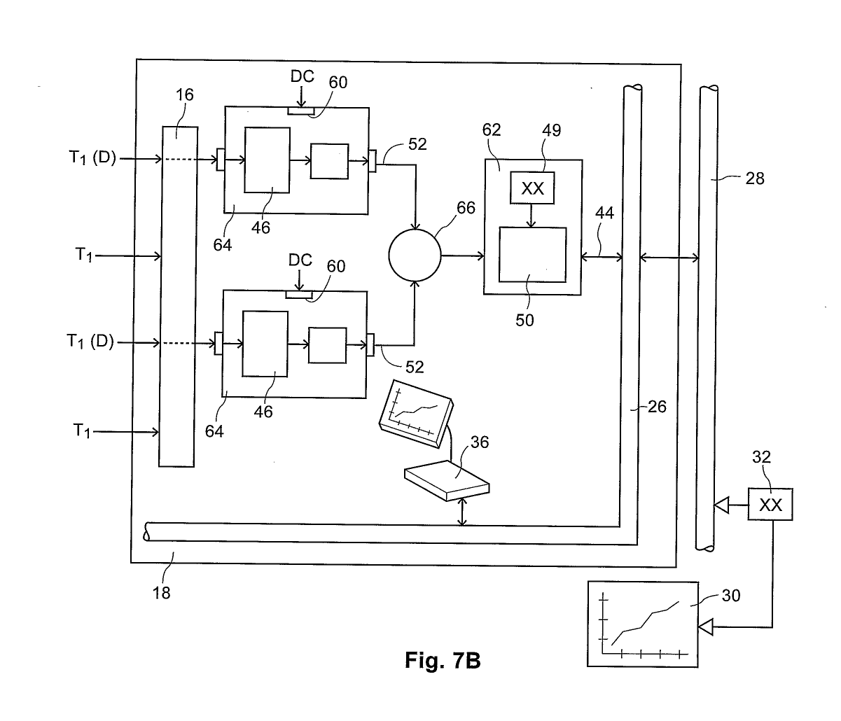

The operation of the present invention can now be described. The first step is to install the management device in a telecommunication system having one or more T1 telephone lines. A representative business site incorporating the management device of the present invention is shown in FIGS. 7A and 7B. As may be seen in the drawings, FIG. 7A shows use of the single board or first embodiment of FIG. 5, and FIG. 7B shows use of the two unit or second embodiment of FIG. 6.

The business site of FIGS. 7A and 7B has a PBX 16, local processor 36, and local area network 26 connected to the broader Internet 28. The data stream processor 30 is located at IP address 32 on the Internet 28. As indicated, the site has four input T1 lines. The first line, designated T1 (D), has one control or D-channel and accordingly 23 remaining voice or B channels. The second T1 has 24 voice or B channels, which are controlled by the D-channel in the first T1. Similarly, the third T1 line has a control or D-channel that controls the remaining 23 voice channels in that line and the 24 voice channels in the fourth line.

In order to determine the hardware requirements of a particular site, the operator should know the number of D-channels to be monitored. In this case there are two D-channels, or alternatively, two T1 lines containing D-channels to be monitored. Another factor in setting up a site is to obtain the location of the destination processor where the user desires that the control data be sent for analysis. As will be discussed further, this will preferably be the Internet or network IP address 32 of the data stream processor 30.

Turning first to FIG. 7A, the operator will select two of the single board management devices 40, since there are two D-channel T1 lines to monitor. The boards 40 may be installed in empty slots or racks of the PBX 16, if available, or alternately mounted on a nearby wall or other surface. The inputs to the boards may be made by connecting standard cables from monitoring jacks for the first and third T1 lines, which are generally available on the PBX 36 or the Pair Gain units of the T1, to the communication line means or input connectors 56 on the boards 40. The output of each board can be connected to the network 26 through the network means 58 comprising standard ethernet RJ45 connectors attached to or built into the boards 40. Power to the boards 40 may be provided by DC adaptors plugged into nearby electrical outlets and connected to the power means 60.

FIG. 7A also illustrates an alternate way of connecting the boards to the network. As shown in dashed line, the boards 40 may be connected through the RJ45connectors 58 to an ethernet or network hub 66. The hub 66 generally contains several ports, one or more of which are selectively used to receive input signals, and another one or more of which may be used as output ports. In FIG. 7A a 3-way hub 66 is used, in which two input ports 68 and 70 receive the output signals 44 from the boards 40, and an output port 72 connects to the network 26. The use of a hub 66 will generally be more convenient as the number of D-channels to be monitored increases. More particularly, for sites having about five or more D-channels, it may be convenient to use a “Power Over Ethernet” (“POE”) hub 66. The POE hub has the advantage of providing power on the ethernet cable itself, so that the separate DC adaptors and wire connections to the device 40 could be eliminated.

Upon activation of power, the management devices 40 will preferably function as network devices and broadcast a request for an IP address and other network parameters. The processing associated with converters 50, if available, will transmit a message to the data stream processor 30 advising the processor of their installation at the site 18, and check for software updates. The processor 30 will provide the identity of the destination network address 49, and this will be entered into the appropriate memory slots or locations 47 on each of the boards 40. Alternatively, if the board 40 is so configured, the destination network address 49 may be entered manually by an operator at the site. The decoders 46 will also start reading the input T1 lines, and upon synchronization will decode and output the D-channel control information.

In FIG. 7B the operator will select two boards or decoder cards 64, in order to monitor the two T1 lines containing D-channels. Only a single stand-alone computer 62 will generally required for the site, since one computer 62 can accommodate the encoding function required by multiple D-channels. A hub 66 is generally preferred when using the second embodiment of the management device 40, because the stand-alone computer 62 will often be provided with only one ethernet input port. As before, a POE hub 66 is generally preferred for installations monitoring a large number of D-channels. In FIG. 7B the stand-alone computer 62 and hub 66 will need to be plugged into a power source. Otherwise, the various connections and procedures are generally similar to that of the first embodiment shown in FIG. 7A.

It can now be appreciated that the management device of the present invention is easy to install and is conveniently powered, whether by a DC adaptor or a POE hub. It can also be appreciated that the device can generally be provided at low cost, since the only hardware requirements are a single board, and possibly a minimally-featured stand-alone computer.

Upon installation and activation of the management device 40 at a business site 18 or telephone company central office 14, the monitoring of the multiplexed telephone signals from the T1 telephone lines may proceed.

With reference to FIG. 7B, the full multiplexed telephone signals from the first and third T1 lines are received at the PBX 16 or T1 Pair Gain units, and corresponding signals from a tap or other monitor point are passed to the decoder cards 64. The decoders 46 read the full input stream at the T1 frequency or bit rate, and synchronize with it so that the B and D-channel information packets can be recognized. The B channel signal is discarded and the D-channel information is passed on at output 52. The decoder also applies header and/or footer tags or bits to the output 52 as appropriate to facilitate transmission in the local environment. This may include, for example, applying tagging compatible with the UDP network protocol. The data from the two boards pass through hub 66 and enter the stand-alone computer 62.

Inside the computer 62 there is recorded the destination network address 49, containing the network address of the destination where the D-channel data is to be delivered. The converter 50 receives as input the D-channel data from the hub 66 and the destination network address 49. The converter 50 in most cases first removes any headers, footers, or other tag information, and then applies new tag information that follows the network compatible protocol being employed, and that is addressed to the destination network address 49. In this way, when the output signal 44 is transmitted over the network 26, the individual data packet will be routed by the network to the destination network address. This is represented in FIG. 7B by the destination network address 49 inside computer 62 having the address “XX”, and the destination 32 on the Internet 28, where the data is received, having the address “XX”.

Preferably the output signal 44 will be transmitted through a dedicated port and under the SSL Internet protocol, which provides a secure and continuous pipeline for the data to the processor 30. Preferably the network 26 will also provide a second outbound port so that the computer 62 can communicate other information with the data stream processor 30. Upon receiving the output signal 44, the processor 30 strips the tag information and saves the D-channel information. The accumulated D-channel data stored in computer memory forms an historical database of the telephone usage of the particular business site 18 being monitored.

In acquiring the D-channel control data from the site 18, the data stream processor 30 has available to it essentially all of the telephone usage information from that site. This information includes real time information, as the data stream being received relates to telephone calls that are either current or that had just been completed moments earlier. The information is also historical, as there is stored in accessible memory records of all phone calls at the site going back to the moment the management device 40 of the present invention was activated.

The data stream processor 30 and/or reports processor 31 will preferably be provided with software for analysis and reporting on the data being received. This database or “back end” software may be configured to provide both real time and historical reports on the data. The reports can then be accessed by a user or manager of the telecommunication system simply by accessing the reports processor 31. For example, a user of the local processor 36 of the site 18 can access, via the Internet, the real time and historical reports being generated at data stream processor 30. The real time reports can provide important current information if there is a telephone problem at that time at the site 18. The historical reports can be prepared to correspond to any desired historical period within the period of usage of the telecommunication management system, as long as all the data has been stored in a location accessible to the processor 30.

It can also be appreciated that if desired, the destination network address could be sent to the local processor 36. In that case the local processor would need to be outfitted with the database or back end software, or a subset of it, otherwise contained in the processors 30 or 31. By avoiding transmission of data over the Internet, this configuration may be preferable to users having serious privacy concerns.

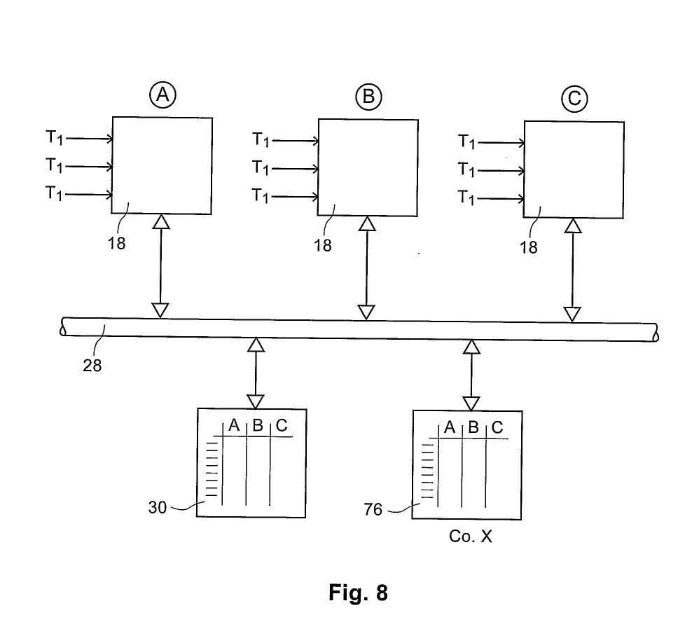

FIG. 8 illustrates an application of the telecommunication management system in a multi-site system. In this case a large company “Co. X” is shown with a central corporate or headquarter office accessible at a website 76. Company X has three call centers or sites 18, shown as “A”, “B”, and “C”, each of which has multiple T1 lines. In the past, telephone data from each site may well have been lost, or available only within the local office. However, upon installation of the telecommunication management system devices of the present invention at each call center, and providing each with a common destination network address such as IP address 32, all of the data from the three sites may be directed to the data stream processor 30. There the data will be recorded to add to the historical record, and available in real time for review by company management at the corporate office 76, or by local company management at the individual sites.

The device and method of the present invention also enable a customer or administrator to remotely test the system by delivering a “simulated” telephone call to the system. For example, monitoring the incoming data stream at data stream processor 30 could reveal a potential problem. Rather than wait for further appropriate data to arrive, which may take some time, the user of the present invention could send a return message to the device 40 telling it to send a particular message into the D-channel, which would elicit a response up or down the T1. Then, upon comparing the actual result to the expected result from the known “call”, the nature of the error or problem may be more accurately diagnosed.

It can now be appreciated how the management device of the present invention provides complete D-channel data of all telephone usage at a site using T1 telephone lines, and how the data may be directed to any destination or processor accessible on a local or broadband network. It can further be appreciated how the management system is able to analyze the data and provide comprehensive real time and historical reports to the management of the T1 telephone systems, including consolidated reports spanning more than one site.

The telecommunication management system of the present invention enables a wide variety of reports to be generated. Examples of some of the reports available in a number of categories are provided below, for both real-time and historical data.

| Category | | Reports |
|---|---|---|
| 1. | Alarms | Real Time: 911, 976, Nuisance calls, inappropriate outbound |
| | | calls, inappropriate toll destination, D-channel failure, imminent |
| | | D-channel failure, excessive Layer 2 error rate, Back-up |
| | | D-channel usage, Capacity Threshold maximum (user induced |
| | | and/or trunk side), Central Office Trunkside failure, User side |
| | | equipment failure, inappropriate Time-of-day usage. |
| | | Historical: Network/Internetworking call failures, Increasing |
| | | pattern of Layer 2 errors, report by extension of any suspicious |
| | | toll usage, hacker pattern identification. |
| 2. | Capacity | Real Time: B-channel utilization, Toll and Toll Free utilization, |
| | | inbound blocked calls, outbound blocked calls, live extension |
| | | monitor, ACD queue monitor, switchboard monitor, virtual facility |
| | | group monitor, etc.. Multi Central office trunk side capacity, multi- |
| | | user side capacity. |
| | | Historical: all above but measured and compared over time. |
| | | Hourly, Daily, Weekly, Monthly, Quarterly, Annually and more. |
| | | Data storage of all traffic statistics can be done for as long as the |
| | | client chooses. |
| 3. | Call Detail | Real Time: Filtered view of any internal or external number or |
| | | group of numbers (Main ACD queue DN, to inbound nuisance |
| | | calls from competitor, to inbound or outbound calls to suspicious |
| | | destinations). |
| | | Historical: all call details from all inbound and outbound |
| | | connected or blocked calls can be kept for a variety of analysis |
| | | indefinitely to generate valuable marketing, VOIP app, toll |
| | | negotiation, data network plan. |
| 4. | Traffic Analysis | Real Time: discrete traffic types identified and monitored in real |
| | | time. Bandwidth utilization, destination utilization (private network |
| | | versus public network). |
| | | Historical: trend analysis on aforementioned traffic types. |
| | | Modeling of current and future traffic, marketing campaign |
| | | correlation analysis, seasonal analysis. |
| 5. | Cost Analysis | Historical: comparative analysis modeled on various ISDN-PRI |
| | | providers. VOIP cost/benefit analysis, private line cost/benefit. |
| | | Staffing analysis. Marketing campaign effectiveness analysis. |
| 6. | Fraud Detection | Historical: fraud pattern analysis, subtle inbound toll free misuse |
| | | detection, subtle outbound toll misuse detection. Call center |
| | | agent “trick” detection, excessive long calls by DN, excessive |
| | | short calls by DN. |
| 7. | Aggregate Serving | Real Time: Central Office failure, Central Office Congestion, |
| | Central Office | Central Office Signaling problems. |
| | | Historical: aggregate traffic, aggregate errors compared to other |
| | | Central Offices, aggregate uptime, aggregate downtime, |
| | | aggregate internetworking problems. |
| 8. | Aggregate | Real Time: trunk congestion during abnormal “events”, i.e.: |
| | Client Side | Storms, civil unrest, media events. |
| | | Historical: normative comparison of all above reports. |
| 9. | VOIP (voice over | Real Time: voip configuration parameters applied to all above |
| | Internet protocol) | measurement reports. |
| | | Historical: model potential VOIP configuration over existing |
| | | non-VOIP for implementation analysis, upon implementation |
| | | apply VOIP configuration to all above reporting options. |
| 10. | Private Line | As per VOIP on both Real Time and Historical applications. |

All of the reports produced by the telecommunication management system of the present invention, including the example reports listed above, can be tailored to create an additional type of report called a “Service Level Assurance/Service Level Objective” (“SLA/SLO” report). The SLA/SLO reports enable cross-referencing of data to uncover obscure but very valuable correlations. For example, “Capacity Busy Signal Alarm Thresholds” can be compared to “Historical Traffic Analysis” to pin-point the convergence of low channel utilization and high return busy signal rates. This SLA/SO report may well identify surprising instances of inadequate staffing levels. It can be appreciated that the information available in SLA/SLO reports may be useful to service providers as well as their business customers. Further, in providing detailed, cross-referenced analyses of telephone traffic data, the reports may be helpful in resolving disputes between service providers and their customers over service degradation.

Another aspect of the present invention is that it makes possible data modeling that is very wide ranging or global in scope. Since all or most telephone traffic data gathered from all installed locations may be housed in one database, data stream processor 30, it will be possible to create reports that compare entire industries with each other, and entire service providers with each other. Over time, the information gathered will continue to increase in value and become part of regional, national, and international or global traffic and performance studies that will deliver valuable aggregate traffic and performance information. As a result, some additional types of reports may be possible, such as “Aggregate Call-Center Industry Performance”, or “Finance Industry Aggregate Reports”. The latter report, for example, maybe particularly useful during periods of very active financial activity, such as high volume trading days, or the RRSP retirement account season in Canada. The availability of these reports will enable various industries to compare their business performance to that of their industry as a whole.

It can accordingly be appreciated that using a single database to capture all data from all users and providers will provide the raw material to discern more trends and correlations, which would facilitate even larger and more customized reports to be created. Every time a new report or valuable correlation is discovered, it can be applied to the data set retroactively to reveal information that would otherwise be lost forever. Such trending and historical analysis will begin on the day of the first site installation, and grow in value as additional sites are added.

It can be appreciated that the present invention further describes a method of providing telecommunication management services. The method involves installing at least one telecommunication system management device at a site receiving a multiplexed telephone signal. This may include a central office of a telephone service provider, or the site of a customer of the provider. The method further involves directing control information from the management device to a processor. The processor is preferably located at an Internet IP address, where it can be easily accessed by T1 sites at any location with Internet access. The processor analyzes the control information and provides reports of the analyzed information to a user, manager, or owner of the multiplexed telephone signal.

The devices installed by the operator comprise at least a decoder/ethernet card for each T1 channel having control information at the site, and may include a dedicated but inexpensive, reduced component computer for each site. The operator of the method accordingly may provide hardware devices and software reports to the customer. Alternatively, the operator may provide the hardware devices alone and direct the information flow to the user's local processor, for processing by the user.

The method of the present invention accordingly gives rise to at least two ways to improve delivery of telephone services. In one case, the management devices and report services may be provided to business users of multiplexed T1 telephone systems. In another case, the devices and services may be provided to telephone company providers, who would benefit by being able to provide more reliable telephone service, and thereby achieve greater customer satisfaction and sales.

It will be appreciated by those skilled in the art that the foregoing description was in respect of preferred embodiments and that various alterations and modifications are possible within the broad scope of the appended claims without departing from the spirit of the invention. For example, while reference is made to housing the decoder on an electronic card, other types of containers or housing may also be used if desired. Various other modifications will be apparent to those skilled in the art but are not described in any further detail herein.

1. A telecommunication system management device, said device comprising:
(a) a means to connect the device to a source of power;
(b) a means to connect the device to a multiplexed telephone signal;
(c) a means to provide said device with a destination network address;
(d) a decoder, to receive said multiplexed telephone signal and to extract control information from said multiplexed telephone signal;
(e) a converter, to receive inputs comprising said destination network address and said extracted control information, and to convert said inputs into a network compatible output signal; and
(f) a means to connect the device to a network, to permit said device to transmit said output signal over the network;
wherein, said extracted control information can be sent to said destination network address.

2. The telecommunication system management device according to claim 1, wherein said multiplexed telephone signal follows the T1 telecommunication standard, and said control information comprises layers 2 and 3 data from a control D-channel.

3. The telecommunication system management device according to claim 1, wherein said Internet compatible protocol follows the TCP/IP telecommunication standard.

4. The telecommunication system management device according to claim 1, wherein said destination network address and said converter are housed in a computer processor.

5. A method of monitoring a multiplexed telephone signal, said method comprising:
(a) receiving said multiplexed telephone signal;
(b) decoding control information from said multiplexed telephone signal;
(c) selecting a destination network address;
(d) converting said control information and said destination network address to an output signal containing said control information and having an Internet compatible protocol addressed to said destination network address;
(e) transmitting said output signal over the Internet to said destination network address;
(f) decoding said control information at said destination network address;
(g) analyzing said control information on a processor at said destination network address; and
(h) providing said analyzed control information to a user of said multiplexed telephone signal.

6. A method of providing telecommunication management services, said method comprising:
(a) installing a telecommunication system management device at a site receiving a multiplexed telephone signal;
(b) directing control information from said management device to a processor;
(c) analyzing said control information on said processor; and
(d) providing reports of said analyzed information to a user of said multiplexed telephone signal.
